(19) United States
(12) Patent Application Publication
(10) Pub. No.: US 2025/0245295 A1
(43) Pub. Date: Jul. 31, 2025

(54) SYSTEMS AND METHODS FOR SEGMENTATION USING ENSEMBLE NEURAL NETWORKS

(71) Applicant: Walmart Apollo, LLC, Bentonville, AR (US)

(72) Inventors: Akash Daxeshkumar Patel, Sunnyvale, CA (US); Chia-Yen Ho, Cupertino, CA (US); Hongyao Huang, Newark, CA (US); Ishan Karanwal, San Francisco, CA (US); Topojoy Biswas, Pleasanton, CA (US); Yokila Arora, San Jose, CA (US); Sushant Kumar, San Jose, CA (US); Kannan Achan, Saratoga, CA (US)

(21) Appl. No.: 19/025,717

(22) Filed: Jan. 16, 2025

Related U.S. Application Data
(60) Provisional application No. 63/627,273, filed on Jan. 31, 2024.

(51) Int. Cl. G06F 18/213; G06F 18/2415

(52) U.S. Cl. CPC G06F 18/213; G06F 18/2415

(57) ABSTRACT

Systems and methods of user segmentation and customized interface generation are disclosed. A user data structure including a set of user features is obtained. A segment probability for each of a plurality of segments is generated by a deep neural net classifier model that receives a first subset of the user features. A classification probability of the user data structure is generated for each of the plurality of segments by a data segmentation model configured to receive the segment probability from the deep neural net classifier model and a second subset of the user features. A user-application-segment score is generated based on a weighted combination of the segment probability and the classification probability for the at least one of the plurality of segments. The weighted combination is applied by a combinatorial model. The user data structure is modified to include an application-specific label based on the user-application-segment score.

### CROSS-REFERENCE TO RELATED APPLICATION

This application claims benefit under 35 U.S.C. § 119(e) to U.S. Provisional App. Ser. No. 63/627,273, filed Jan. 31, 2024, entitled “Systems and Methods for Segmentation Using Ensemble Neural Networks,” the disclosure of which is incorporated by reference herein in its entirety.

### TECHNICAL FIELD

This application relates generally to segmentation of data, and more particularly, to segmentation utilizing deep neural network and segmentation models.

### BACKGROUND

Segmentation of data structures allows for application of different processes and/or actions based on classifications. Some current systems segment data structures based on use case specific factors, such as factors relating to specific portions of an interface or specific system dispositions. Such segmentation fails to provide a generalized segmentation of the data structures across multiple dispositions.

As one example, in the context of an e-commerce environment, user data structures may be segmented into different classifications based on user features and/or interface features related to specific use cases, such as homepage personalization, email campaigns, ad selection, etc. Current systems segment user data structures utilizing use case-specific features and are not capable of providing user data structure segmentation that provides segmentation that accounts for features across multiple use cases or facets.

### SUMMARY

In various embodiments, a system including a non-transitory memory and a processor communicatively coupled to the non-transitory memory is disclosed. The processor is configured to read a set of instructions to obtain a user data structure comprising at least one data element representative of a set of user features and generate a segment probability for each of a plurality of segments for the user data structure. The segment probability for each of a plurality of segments is generated by a deep neural net classifier model configured to receive a first subset of the set of user features. The processor is further configured to generate a classification probability of the user data structure for each of the plurality of segments by a data segmentation model configured to receive the segment probability for each of the plurality of segments from the deep neural net classifier model and a second subset of the set of user features and generate a user-application-segment score based on a weighted combination of the segment probability for at least one of the plurality of segments and the classification probability for the at least one of the plurality of segments. The weighted combination is applied by a combinatorial model. The processor is further configured to modify the user data structure to include an application-specific label based on the user-application-segment score.

In various embodiments, a computer-implemented method is disclosed. The computer-implemented method includes steps of receiving a user data structure comprising at least one data element representative of a set of user features and generating a segment probability for each of a plurality of segments for the user data structure. The segment probability for each of a plurality of segments is generated by a deep neural net classifier model configured to receive a first subset of the one or more user features. The computer-implemented method further includes steps of generating a classification probability of the user data structure for each of the plurality of segments by a data segmentation model configured to receive the segment probability for each of the plurality of segments from the deep neural net classifier model and a second subset of the one or more user features and generating a user-application-segment score based on a weighted combination of the segment probability for at least one of the plurality of segments and the classification probability for the at least one of the plurality of segments. The weighted combination is applied by a combinatorial model. The computer-implemented method further includes a step of modifying the user data structure to include an application-specific label based on the user-application-segment score.

In various embodiments, a non-transitory computer readable medium having instructions stored thereon is disclosed. The instructions, when executed by at least one processor, cause at least one device to perform operations including receiving a user data structure comprising at least one data element representative of a set of user features and generating a segment probability for each of a plurality of segments for the user data structure. The segment probability for each of a plurality of segments is generated by a deep neural net classifier model configured to receive a first subset of the one or more user features. The device is further configured to perform operations including generating a classification probability of the user data structure for each of the plurality of segments by a data segmentation model configured to receive the segment probability for each of the plurality of segments from the deep neural net classifier model and a second subset of the one or more user features and generating a user-application-segment score based on a weighted combination of the segment probability for at least one of the plurality of segments and the classification probability for the at least one of the plurality of segments. The weighted combination is applied by a combinatorial model. The device is further configured to perform operations including modifying the user data structure to include an application-specific label based on the user-application-segment score.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide data segmentation and interface generation, in accordance with some embodiments;

FIG. 2 illustrates a computer system configured to implement one or more processes, in accordance with some embodiments;

FIG. 3 is a flowchart illustrating a data segmentation and interface generation method, in accordance with some embodiments;

FIG. 4 is a process flow illustrating various steps of the data segmentation and interface generation method of FIG. 3, in accordance with some embodiments;

FIG. 5 is a block diagram illustrating various portions of a data segmentation system including one or more user data structures, in accordance with some embodiments;

FIG. 6 illustrates a deep neural net classifier model including a deep neural network having an input layer configured to receive each of the DNN-specific feature subsets, a plurality of hidden layers, and an output layer 358, in accordance with some embodiments;

FIG. 7 illustrates a centroid-based classifier configured to segment a data set into a plurality of segments, in accordance with some embodiments;

FIG. 8 illustrates an artificial neural network, in accordance with some embodiments;

FIG. 9 illustrates a tree-based artificial neural network, in accordance with some embodiments;

FIG. 10 illustrates a deep neural network (DNN), in accordance with some embodiments;

FIG. 11 is a flowchart illustrating a training method for generating a trained machine learning model, in accordance with some embodiments; and

FIG. 12 is a process flow illustrating various steps of the training method of FIG. 10, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for data segmentation and interface generation. In various embodiments, a user classification and interface generation system configured to classify one or more user data structures and generate interfaces including interface elements based on the corresponding classification is disclosed. The user classification and interface generation system includes a deep neural net classifier model, a segmentation model, and a combinatorial network. Each of the deep neural net classifier model and the segmentation model are configured to receive sets of features associated with the user data structure, sets of features associated with a network platform, and sets of features associated with user-application interactions. Each of the deep neural net classifier model and the segmentation model are configured to generate segment classifications of the user data structure for one of a plurality of segments. The segmentation model is further configured to receive the output of the deep neural net classifier model. The deep neural net classifier model and the segmentation model are trained utilizing a training dataset generated, at least in part, by an unsupervised classification model. The output of the deep neural net classifier model and the segmentation model are provided to a combinatorial network, which may be configured to apply a set of weights to generate a user-application-segment score. The weights applied by the combinatorial network are generated based on application-specific affinities and/or features.

In some embodiments, the user classification and interface generation system generates one or more interfaces including one or more customized interface elements selected based on a user-application-segment score (e.g., a user-application-segment classification). For example, a user data structure may be classified in one of a plurality of classes for an application based on a user-application-segment score. When an interface is generated for the user and the application, one or more interface elements are customized based on the classification of the user into the corresponding classification.

In some embodiments, systems, and methods for data segmentation and interface generation include one or more trained models. The trained models may include one or more models, such as a trained deep neural network, a trained segmentation model, a trained weighted combination network, etc. Each of the trained models may be generated by a training process configured to apply a supervised, unsupervised, and/or semi-supervised training process.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

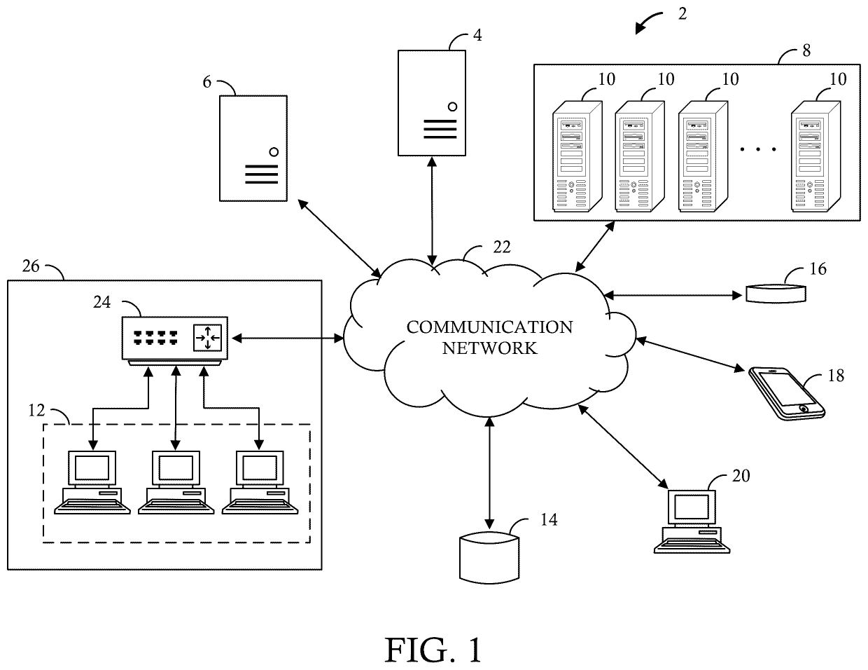

FIG. 1 illustrates a network environment 2 configured to provide user segmentation and interface generation, in accordance with some embodiments. The network environment 2 includes a plurality of devices or systems configured to communicate over one or more network channels, illustrated as a network cloud 22. For example, in various embodiments, the network environment 2 may include, but is not limited to, a user segmentation computing device 4, a web server 6, a cloud-based engine 8 including one or more processing devices 10, a database 14, and/or one or more user computing devices 16, 18, 20 operatively coupled over the network 22. The user segmentation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the user segmentation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the user segmentation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the user segmentation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the user segmentation computing device 4, for example. The workstation(s) 12 may communicate with the user segmentation computing device 4 over the communication network 22. The workstation(s) 12 may send data to, and receive data from, the user segmentation computing device 4. For example, the workstation(s) 12 may transmit data related to tracked operations performed at the physical location 26 to user segmentation computing device 4.

Although FIG. 1 illustrates three user computing devices 16, 18, 20, the network environment 2 may include any number of user computing devices 16, 18, 20. Similarly, the network environment 2 may include any number of the user segmentation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the user segmentation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, click on interface elements presented via the website, for example, in the search results, etc. The website may capture these activities as user session data, and transmit the user session data to the user segmentation computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the user segmentation computing device 4.

In some embodiments, the user segmentation computing device 4 may execute one or more models, processes, or algorithms, such as a machine learning model, deep learning model, statistical model, etc., to segment data structures (e.g., user data structures) into one of a plurality of segments (e.g., classes) for a specific application. The user segmentation computing device 4 may transmit a data-application segmentation score (or corresponding data classification) to the web server 6 over the communication network 22, and the web server 6 may display interface elements associated with a corresponding data segment and/or data classification on the website to a user. For example, the web server 6 may display interface elements associated with one of a plurality of user segments to a user on a homepage, a catalog webpage, an item webpage, a window or interface of a chatbot, a search results webpage, or a post-transaction webpage of the website (e.g., as the user browses those respective webpages).

In some embodiments, the web server 6 transmits a segmentation request to the user segmentation computing device 4. The segmentation identification request may include a request for identification of a segment associated with a user identifier for a particular application, context, etc. The user identifier may be included in the segment identification request. A segment (e.g., segment identifier, segment title, etc.) for a segment associated with the user identifier for the particular application may be retrieved from a data store and/or generated by a segmentation process, as discussed in greater detail below. The segment identification is sent in response to the segmentation identification request and the web server 6 may generate one or more interfaces including one or more segment-specific interface elements in response.

In some embodiments, a user submits a query on a website hosted by the web server 6. The web server 6 may send a segment identification request to the user segmentation computing device 4. In response to receiving the segment identification request, the user segmentation computing device 4 may execute one or more processes to determine a user segment associated with a user identifier for a particular application and transmit the results including the identified segment to the web server 6 to generate an interface be displayed to the user.

The user segmentation computing device 4 is further operable to communicate with the database 14 over the communication network 22. For example, the user segmentation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the user segmentation computing device 4, in some embodiments, the database 14 may be a local storage device, such as a hard drive, a non-volatile memory, or a USB stick. The user segmentation computing device 4 may store interaction data received from the web server 6 in the database 14. The user segmentation computing device 4 may also receive from the web server 6 user session data identifying events associated with browsing sessions, and may store the user session data in the database 14.

In some embodiments, the user segmentation computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The user segmentation computing device 4 and/or one or more of the processing devices 10 may train one or more models based on corresponding training data. The user segmentation computing device 4 may store the models in a database, such as in the database 14 (e.g., a cloud storage database).

The models, when executed by the user segmentation computing device 4, allow the user segmentation computing device 4 to generate segment data elements for one or more particular application identifiers for each of a plurality of users. For example, the user segmentation computing device 4 may obtain one or more models from the database 14. The user segmentation computing device 4 may then receive, in real-time from the web server 6, a segment identification request. In response to receiving the segment identification request, the user segmentation computing device 4 may execute one or more models to segment (e.g., classify) a user identifier associated with the segment identification request into one of a plurality of segments for a particular application identified in the segment identification request.

In some embodiments, the user segmentation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, user segmentation computing device 4 may generate a segment identification that is provided for generation of one or more interfaces including one or more segment-specific interface elements.

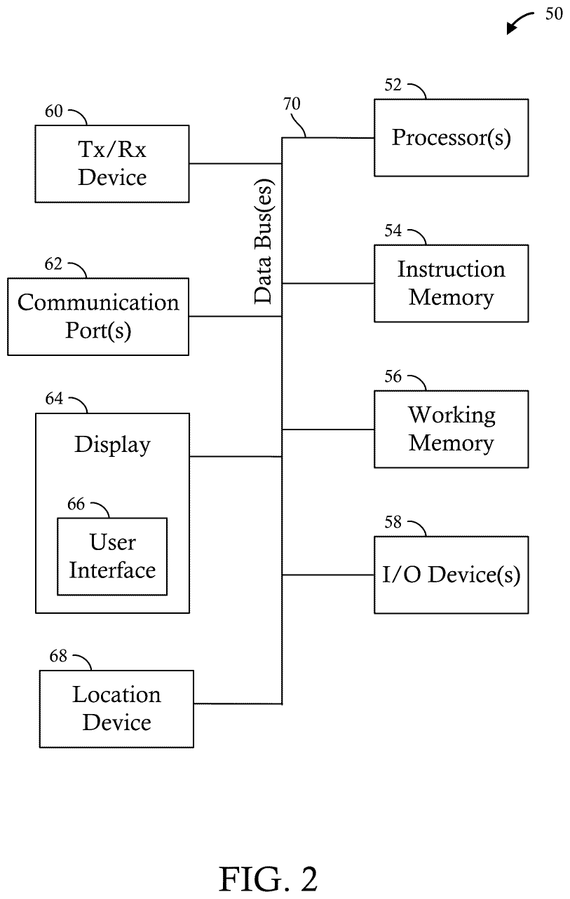

FIG. 2 illustrates a block diagram of a computing device 50, in accordance with some embodiments. In some embodiments, each of the user segmentation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating application-specific segment classifications and interface generation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with interfaces including segment-specific interface elements. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

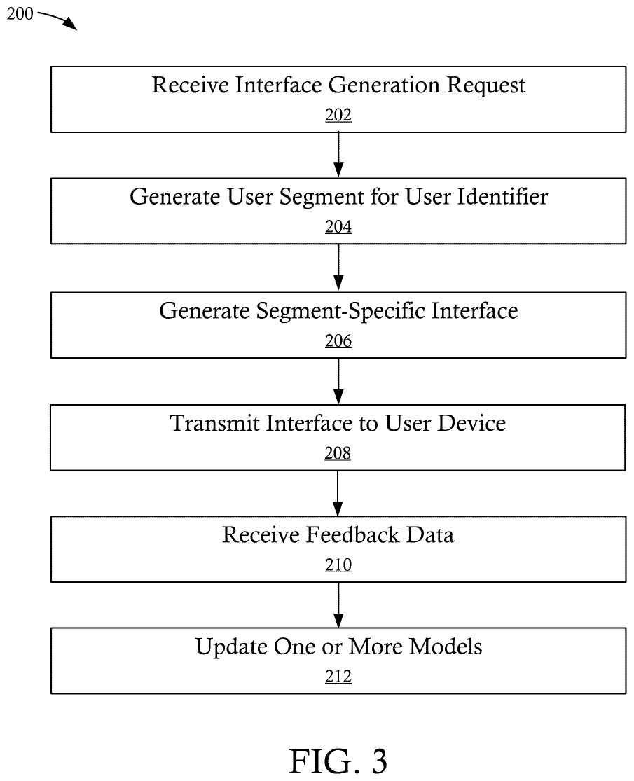

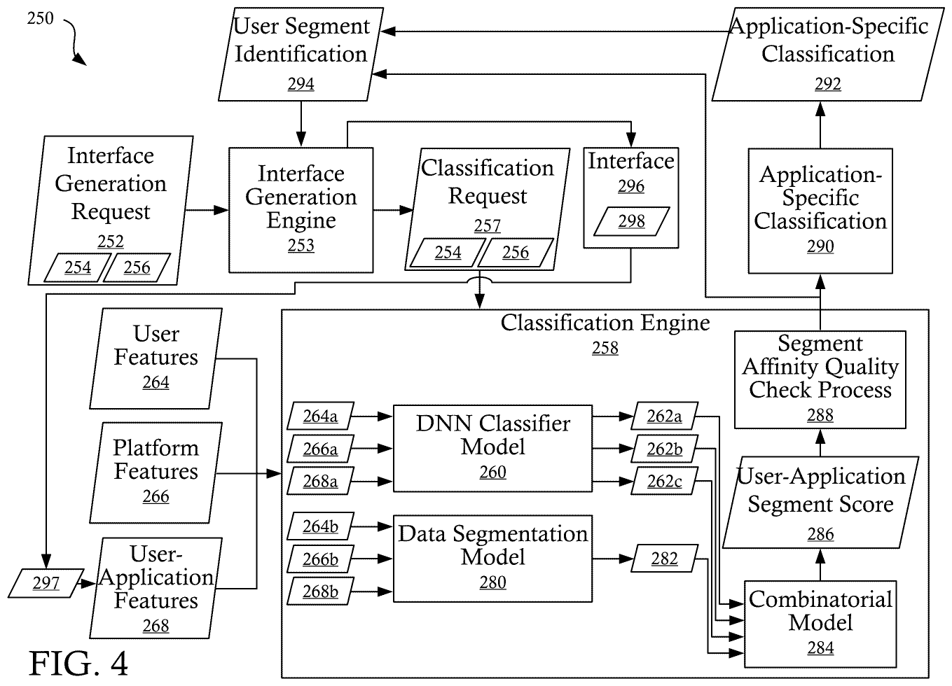

FIG. 3 is a flowchart illustrating a user segmentation and interface generation method 200, in accordance with some embodiments. FIG. 4 is a process flow 250 illustrating various steps of the user segmentation and interface generation method 200, in accordance with some embodiments. At step 202, an interface generation request 252 is received. The interface generation request includes a user identifier 254 associated with a user data structure. The user data structure includes one or more data elements including, but not limited to, one or more data elements representative of user features (e.g., self-reported information, user preferences, membership status, etc.), historical interaction data (e.g., data representative of prior interactions with interface elements included in an interface presented via a user device associated with the user identifier), and/or any other suitable user data. The interface generation request 252 may be received by any suitable process, module, engine, etc., such as an interface generation engine 253.

In some embodiments, the interface generation request 252 includes an application identifier 256 associated with a network application associated with and/or being used for the interface. For example, the application identifier 256 may identify one or more network applications such as a communication application (e.g., email, instant messaging, etc.), and/or any other suitable network application.

At step 204, a user segment identification 294 is generated for the user identifier 254. The user segment identification 294 is representative of a segment classification for of the user identifier 254 into one of a plurality of segments for the network application corresponding to the application identifier 256. In some embodiments, a classification request 257 is generated by the interface generation engine 253 and provided to a classification engine 258. The classification engine 258 is configured to classify a user data structure associated with the user identifier 254 into the one of the plurality of segments by implementing and/or executing one or more trained models. The classification engine 258 may include an ensemble framework having multiple trained models with the output of at least a first model in the ensemble being provided as an input to at least a second model.

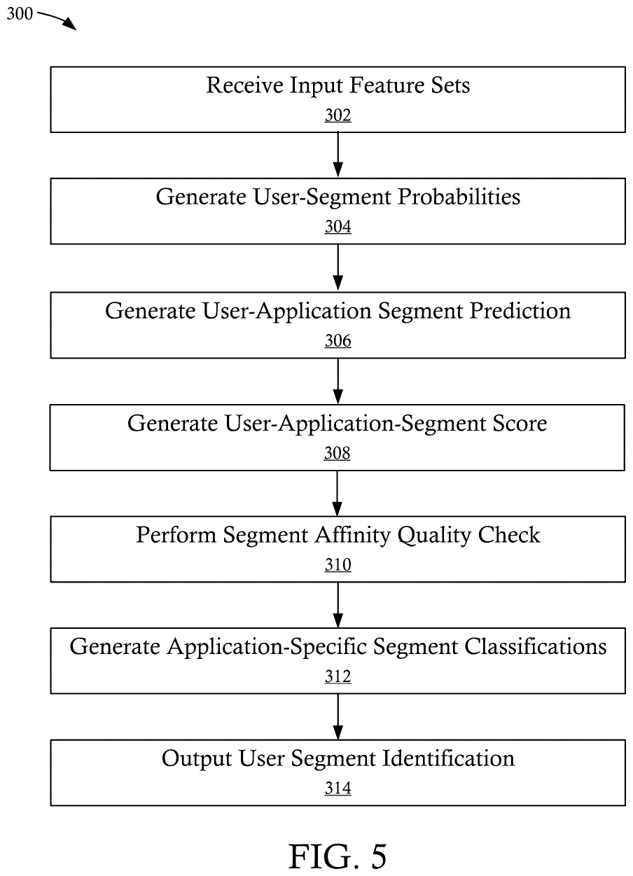

FIG. 5 illustrates a classification method 300, in accordance with some embodiments. In some embodiments, the classification method 300 is implemented by an ensemble model framework including a deep neural net classifier model, a user segmentation model, and a combinatorial network to generate a user-application-segment score for assigning the corresponding user identifier 254 to one of a plurality of segments with respect to the corresponding network application identifier 256. Although specific embodiments are discussed herein, it will be appreciated that the disclosed ensemble model framework may be used to classify user data structures into any suitable set of segments for one or more corresponding applications.

At step 302, one or more sets of input features, such as user features 264, platform features 266, and/or user-application features 268 are generated and/or obtained. Each of the sets of features 264, 266, 268 may be generated by a feature extraction process (e.g., user feature extraction process 265, platform feature extraction process 267, etc.) and/or may pre-generated and stored in a datastore, such as the set of user-application features 268 stored in a user-application datastore 14c. Although separate processes are illustrated, it will be appreciated that the same feature extraction process and/or the same datastore may be utilized to obtain each of the set of user features 264, the set of platform features 266, and/or the set of user-application features. The set of user features 264, the set of platform features 266, and/or the set of user-application features may be provided in any suitable format, such as, for example, a set of data elements, a set of vectors, a set of embeddings, etc.

The set of user features 264 may include user preference data for a user based on attributes associated with that user. For example, the user preference data may identify and characterize attributes associated with a user during one or more interactions with one or more network applications associated with a network environment. In some examples, more than one attribute per attribute category (e.g., brand, type, description) may be identified. When generating user preference data for a user, an attribute that is identified most often (e.g., a majority attribute) may be identified. The attribute defined most often in each attribute category is stored as part of the corresponding user preference data. In some examples, a percentage score is generated for each attribute within an attribute category, and the percentage score is stored as part of the user preference data. The percentage score is based on a number of times a particular attribute is identified in a corresponding attribute category with respect to the number of times any attribute is identified in that attribute category. In some examples, the user preference data and/or the corresponding features are stored and/or retrieved from a user feature datastore 14a.

The set of platform features 266 may include platform data for one or more portions of a network platform. For example, the platform data may identify and characterize attributes associated with a plurality of user interactions with the network environment. Similarly, the set of user-application features 268 may include user-application interaction data for one or more network applications. For example, the user-application data may identify and characterize attributes associated with a plurality of user interactions with individual network applications. In some embodiments, user preference data used to generate user platform features and/or predetermined platform features 266 may be stored in a platform datastore 14b.

The set of user-application features 268 may include data related to interactions associated with the user identifier 254 and the application associated with the application identifier 256 (e.g., user interactions with displayed interface elements, completion of one or more activities based on displayed and/or utilized interface elements, etc.). The set of user-application features 268 may provide application-specific inputs, allowing for tuning of a user-application-segment score generation for each network application, such as a network application associated with the network application identifier 256.

At step 304, a set of user-application segment probabilities 262a-262c for a plurality of segments is generated. In some embodiments, the set of user-application segment probabilities 262a-262c is generated by a deep neural network classifier model 260. The deep neural network classifier model 260 may be configured to receive a DNN-specific subset of user features 272a selected from the set of user features 264, a DNN-specific subset of platform features 274a selected from the a set of platform features 266, and/or a DNN-specific subset of user-application features 276a selected from the set of user-application features 268. The DNN-specific subsets 272a, 274a, 276a may include a set of features selected, e.g., during iterative training, for use by the deep neural network classifier model 260.

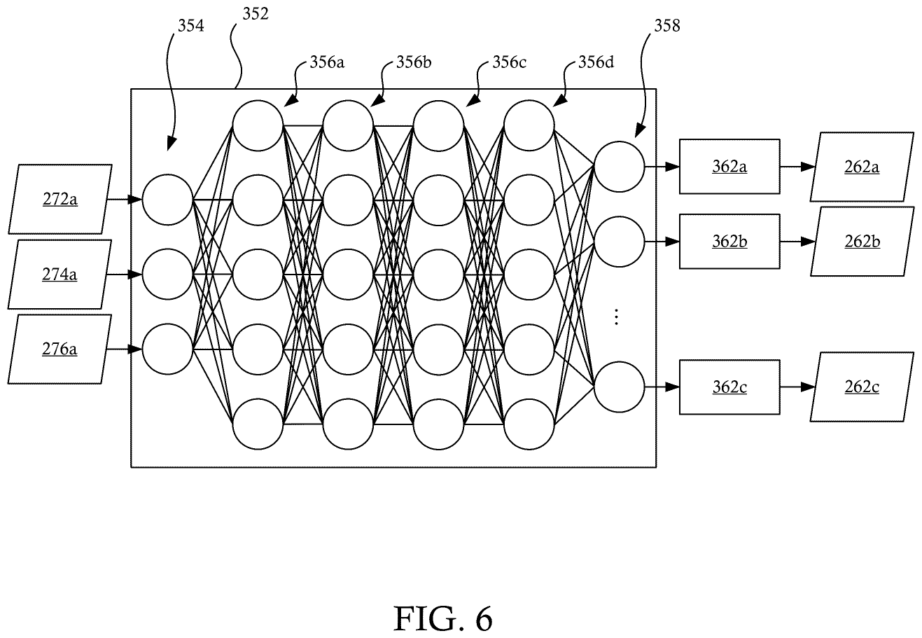

As illustrated in FIG. 6, a deep neural network classifier model 260a may include a deep neural network 352 having an input layer 354 configured to receive each of the DNN-specific feature subsets 272a, 274a, 276a, a plurality of hidden layers 356a-356d, and an output layer 358, in accordance with some embodiments. In some embodiments, the output layer 358 includes a softmax layer configured to apply a softmax function to the output of the hidden layers 356a-356d. In some embodiments, the output of each node of the output layer 358 is provided to an additional softmax layer 360 including a softmax function 362a-362c associated with each output node of the deep neural network 352. Each of the individual softmax functions 362a-362c are configured to condition an output of the deep neural network 352 to generate a user-application segment probability 262a-262c for each of a plurality of segments. A user identifier 254 may be classified into a segments having a highest corresponding user-application segment probability 262a-262c.

In some embodiments, the plurality of segments include predefined segments for a corresponding network environment. For example, the plurality of segments may include segments configured to classify engagement of a user associated with a user identifier 254 with a corresponding network environment. The plurality of segments may include any number of predefined segments, such as, for example, three, four, five, etc. One or more of the plurality of segments may be associated with one or more user behaviors with respect to a network platform. For example, a first segment may be configured to identify users who utilize a first application and/or network service at a high rate, a second segment may be configured to identify users who are likely to convert to the first segment, a third segment may identify users who may engage with the first application, a fourth segment may identify users of the first application corresponding to a specific benefit or intent, etc. Although specific embodiments are discussed herein, it will be appreciated that any suitable number segments associated with any suitable application for a set of data identifiers may be defined.

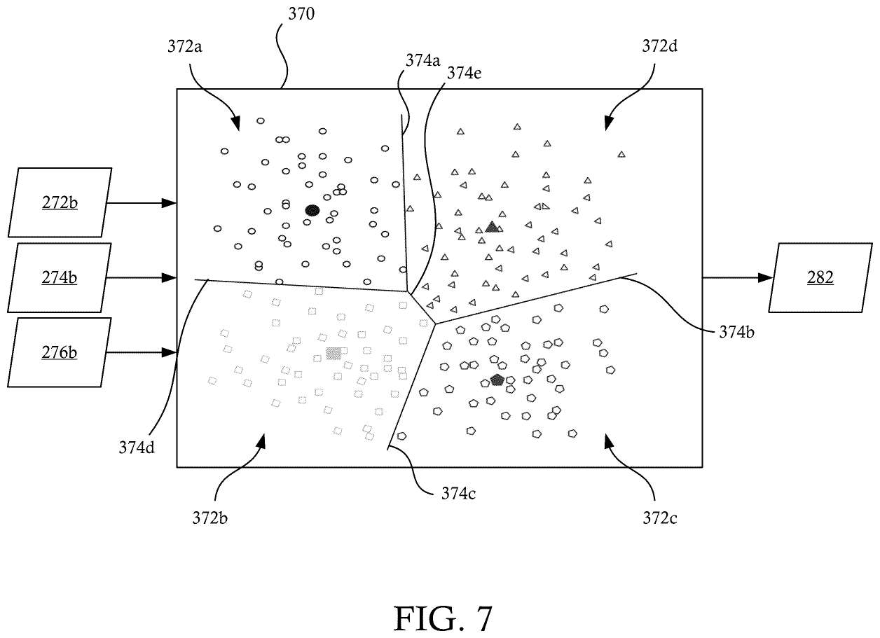

With reference again to FIG. 5, at step 306, a user-application segment prediction 282 is generated by a data segmentation model 280. The data segmentation model 280 may be configured to receive a segmentation-specific subset of user features 272b selected from the set of user features 264, a segmentation-specific subset of platform features 274b selected from the set of platform features 266, a segmentation-specific subset of user-application features 276b selected from the set of user-application features 268, and the user-application segment probabilities 262a-262c generated by the deep neural network classifier model 260 (see FIG. 7). The segmentation-specific subsets 272b 274b 276b include subsets of features selected, e.g., during training, for use by a data segmentation model 280. The DNN-specific subsets 272a, 274a, 276a and the segmentation-specific subsets 272b 274b, 276b may include overlapping and/or non-overlapping subsets of the set user features 264, the set of platform features 266, and/or the set of user-application features 268, respectively. The output of the deep neural network classifier model 260 may include a categorical encoding including a feature based on a label encoding of the output.

In some embodiments, the data segmentation model 280 includes a centroid-based, supervised classifier. As illustrated in FIG. 7, a centroid-based classifier 370 is configured to segment a data set into a plurality of segments 372a-372d, in accordance with some embodiments. The plurality of segments 372a-372d correspond to the plurality of classes. Delineations 374a-374e between classes are defined and each data point within a given segment 372a-372d is assigned a label for the corresponding segment. The label assigned for a corresponding user data structure is output as the user-application segment prediction 282 for the user identifier 254 and the application identifier 256 associated with the interface generation request 252. Although embodiments are illustrated with four segments 372a-372d, it will be appreciated that the centroid-based classifier 370 may be configured to include a number of segments equal to the number of classes in the plurality of classes.

In some embodiments, the deep neural network classifier model 260 and/or the data segmentation model 280 are generated by a training dataset including a set of ideal candidates for each segment in the plurality of segments. For example, a training dataset may include a subset of user data structures that have ideal values for one or more features representative of assignment to one of the plurality of segments. In some embodiments, ideal candidates may be selected by a clustering model configured to cluster a set of user data structures. The clustering model may be configured to cluster each of the user data structures based on a predetermined number of attributes or features (e.g., tens or hundreds of attributes). In some embodiments, the clustering model utilizes one or more time windows, such as, for example, one or more recency windows to filter and/or weight attributes and/or attribute values with respect to an assigned cluster. The clustering model may include an unsupervised clustering model.

In some embodiments, ideal candidates may be selected from one or more clusters associated with a selected label based on a cluster purity score. A cluster purity score may include a value between 0 and 1 indicative of a dominance of a segment within a given cluster (e.g., similarity between a cluster and a segment within the cluster) for a given application. A higher cluster purity score indicates higher homogeneity with respect to cluster members. Ideal and/or representative candidates may be selected for inclusion in the training dataset from segments having higher cluster purity score with respect to one of the plurality of segments (e.g., labels).

With reference again to FIG. 5, at step 308, the outputs of the deep neural network classifier model 260 and the data segmentation model 280 are combined by a combinatorial model 284 to generate a user-application-segment score 286 for the user identifier 254. The combinatorial model 284 may apply one or more weights that may be set holistically, determined by one or more machine learning processes, and/or adjusted based on feedback from one or more processes, such as a segment affinity quality check process, as discussed below. The combination of the outputs of the deep neural network classifier model 260 and the data segmentation model 280 may be performed by a separate combinatorial model 284 and/or may be integrated into one or more additional processes, such as the segment affinity quality check process discussed below.

At step 310, a segment affinity quality check is performed to verify a segment classification corresponding to the user-application-segment score 286 generated by the combined outputs of the deep neural network classifier model 260 and the data segmentation model 280, e.g., the output of the combinatorial model 284. In some embodiments, a segment affinity quality check process 288 obtains a set of features for the user identifier 254 and corresponding sets of features of other user identifiers classified in the same segment corresponding to the user-application-segment score 286. Based on the comparison, the segment affinity quality check process 288 may indicate a valid classification (e.g., where the features of the current user identifier 254 are within a predetermined range of similarity as compared to the features of other users in the same segment) and/or an invalid classification (where the features of the current user identifier 254 are outside of a predetermined range of similarity as compared to the features of other users in the same segment). When a valid classification is determined, the segment affinity quality check process 288 may output a segment classification score and the data classification method 300 proceeds to step 312.

In some embodiments when an invalid classification is determined, a process may be applied to modify and/or refine the weights of the combinatorial model 284. For example, in some embodiments, when the segment affinity quality check process 288 indicates an invalid classification, the user-application-segment score 286, user features associated with the user identifier 254, and/or other relevant information may be provided for review. The review may determine that the user-application-segment score 286 corresponds to a correct segment or that the user-application-segment score 286 misclassified the user identifier 254. Where the segment corresponding to the user-application-segment score 286 is incorrect, the corrected classification, user features, and/or other relevant data may be used to refine one or more of the deep neural network classifier model 260, the data segmentation model 280, and/or the combinatorial model 284 (e.g., by adjusting one or more applied weights). Similarly, where the segment corresponding to the user-application-segment score 286 is determined to have been correct, the user identifier and/or corresponding user-application-segment score 286 may be used to refine the segment affinity quality check process.

The segment affinity quality check process 288 may apply any suitable comparison process, such as a statistic-based comparison process and/or a percentile based process. For example, with respect to a percentile based process, the segment affinity quality check process 288 may determine a percentile rank of one or more features for the user identifier 254 with respect to the segment as a whole. A valid segment classification may include a user identifier 254 being within a predetermined percentile rank with respect to one or more features (e.g., the percentile rank compared to the overall distribution). Although specific embodiments are discussed herein, it will be appreciated that any suitable quality check process may be applied.

At optional step 312, one or more application-specific classifications 292 are generated for one or more additional network applications based on the user-application-segment score 286. In some embodiments, an application-specific classification process 290 is configured to receive the user-application-segment score 286 and validate or modify the user segment classification for one or more additional applications. For example, in some embodiments, the application-specific classification process 290 may be configured to compare one or more user features associated with the user identifier 254 to one or more features of other users having a similar classification for a first application, e.g., the application corresponding to the network application identifier 256, and a classification for a second application. An application-specific classification 292 for the second application may correspond to the classification of additional users with respect to the second application. Although specific embodiments are discussed herein, it will be appreciated that the user-application-segment score 286 may be adapted to one or more application-specific classifications 292 using any suitable process. At step 314, a user segment identification 294 corresponding to at least one of the user-application-segment score 268 and/or one or more application-specific classification 292 is output.

With reference again to FIG. 3, at step 206, an interface 296 including at least one interface element 298 selected based on the application-specific classification 292 and/or the user segment identification 294. The interface 296 may be generated by any suitable process, such as an interface generation process implemented by the interface generation engine 253. The interface generation process may obtain one or more interface templates having one or more slots for insertion and/or presentation of interface elements therein. The interface generation process may further obtain one or more interface elements for insertion into one or more template slots based on the user segment identification 294. For example, a user classified into a first user classification may be presented with a first set of interface elements that are relevant to the first user classification (e.g., providing context-relevant actions and/or navigational shortcuts corresponding to portions of a network interface suitable for interaction by users in the first user classification) and a user classified into a second user classification may be presented with a second set of interface elements that are relevant to the second user classification. The first set of interface elements may include at least one interface element not included in the second set of interface elements and the second set of interface elements may include at least one interface element not included in the first set of interface elements. At step 208, the generated interface 296 is provided to one or more user devices for display and/or interaction.

At step 210, user-application feedback data may be received and additional user-application features 268 may be generated. The user-application feedback data may be indicative of one or more interactions (or lack of interactions) via a user device with one or more interface elements 298 selected based on an application-specific classification 292 and/or a user segment identification 294 for a selected network application. Generated user-application features 268 may be stored in the user-application datastore 14c. Incorporation of additional user-application features 268 generated from user-application feedback data 297 provides for refinement of user segment determinations and user classifications. For example, additionally generated user-application features 268 may be provided to one or more models, such as a deep neural network classifier model 260 and/or a data segmentation model 280 in response to one or more subsequent requests for an interface including the same user identifier 254 associated with the initial interface request 252.

At optional step 212, the additional user-application features 268 generated from the user-application feedback data 297 and/or the user-application feedback data 297 itself may be used to refine and/or retrain one or more models. For example, as discussed above, user-application feedback data 297 may be used to refine or recalculate one or more weights applied by a combinatorial model 284. As another example, in some embodiments, user-application feedback data 297 may be utilized in one or more additional unsupervised clustering processes to generate a training dataset including ideal user representatives for training (or re-training) of the deep neural network classifier model 260 and/or the data segmentation model 280. It will be appreciated that the user-application feedback data 297 may be used in any suitable manner for training and/or re-training any of the models disclosed herein.

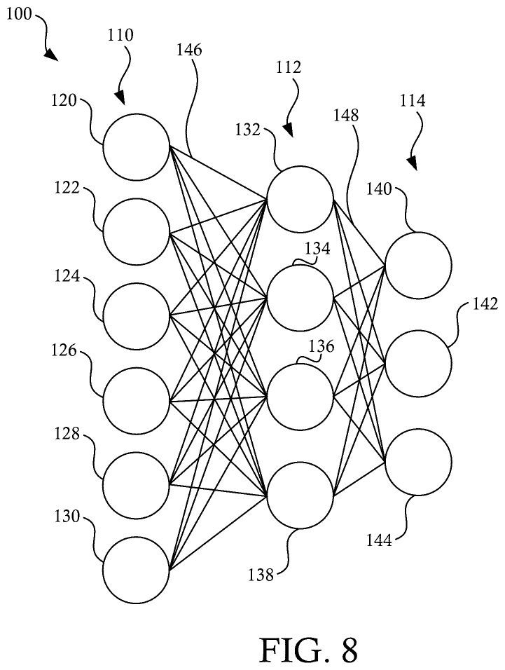

FIG. 8 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 8 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

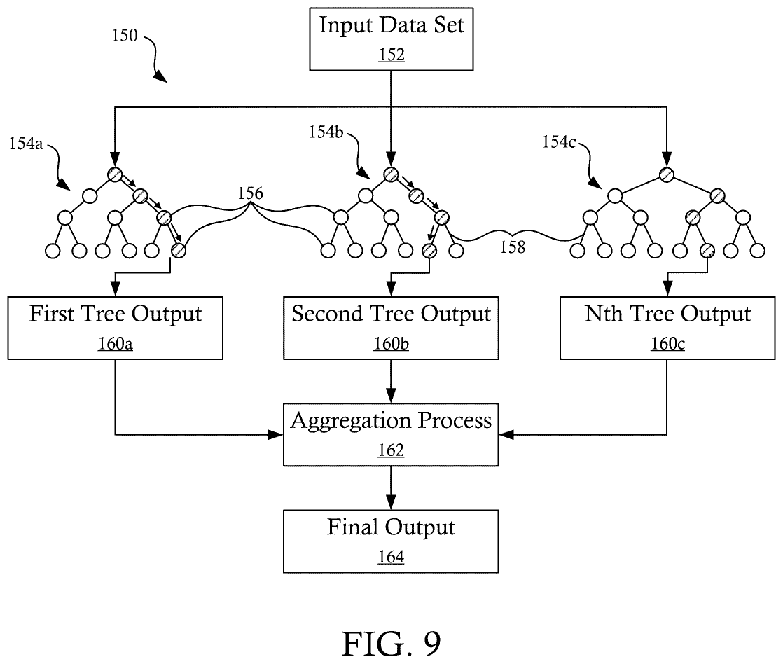

FIG. 9 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

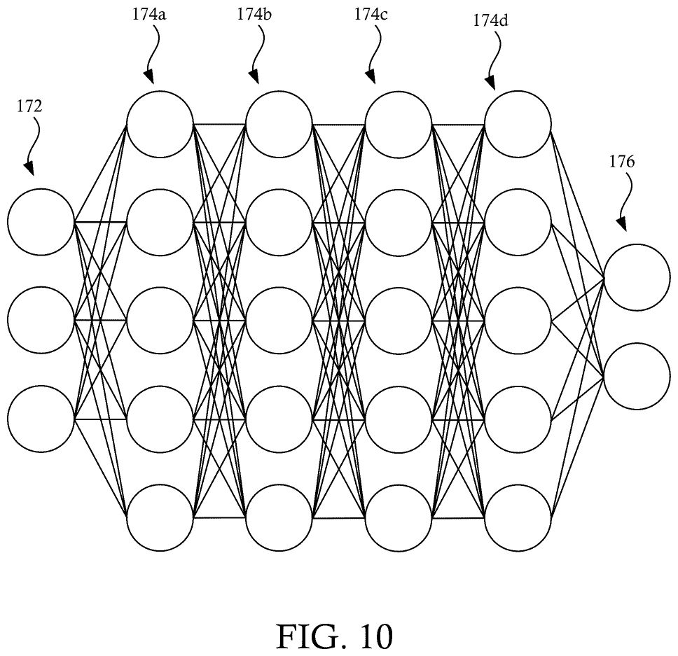

FIG. 10 illustrates a deep neural network (DNN) 170, in accordance with some embodiments. The DNN 170 is an artificial neural network, such as the neural network 100 illustrated in conjunction with FIG. 8, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

y=e^{β}e^{f(log x)}e^{Σ}^{ᵢ}^{f}^{ᵢ}^{^{d}}^{(d}^{ᵢ}⁾

where d represents one or more features of the independent variable x.

Identification of user- and application-specific interface elements associated with a selected user segment can be burdensome and time consuming for users, especially if users are provided only generic interfaces or are segmented based on general characteristics without consideration of application-specific features. Typically, a user may locate information regarding application-specific activities or actions by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding application- and user-specific actions or activities.

Systems including trained models, such as trained deep neural network classifier model 260, a data segmentation model 280, a combinatorial model 284, an unsupervised classification model, etc., as disclosed herein, significantly reduce this problem, allowing users to locate user- and application-specific interface elements with fewer, or in some case no, active steps. For example, in some embodiments described herein, when a user is presented with user-application-segment specific interface elements, each interface element includes, or is in the form of, a link to an interface page for application-specific activities or actions that are relevant to a user given the user's context. Each recommendation thus serves as a programmatically selected navigational shortcut to an interface page, allowing a user to bypass the navigational structure of the browse tree. Beneficially, programmatically identifying user-application-segment specific interface elements and presenting a user with navigations shortcuts to these tasks may improve the speed of the user's navigation through an electronic interface, rather than requiring the user to page through multiple other pages in order to locate the user-application-segment specific interface elements via the browse tree or via a search function. This may be particularly beneficial for computing devices with small screens, where fewer interface elements are displayed to a user at a time and thus navigation of larger volumes of data is more difficult.

It will be appreciated that user-application segmentation and user interface generation including user-application-segment specific interface elements as disclosed herein, particularly on large datasets intended to be used with large network environments including multiple network applications, is only possible with the aid of computer-assisted machine-learning algorithms and techniques, such as a trained deep neural network classifier model 260, a data segmentation model 280, a combinatorial model 284, an unsupervised classification model, etc., In some embodiments, machine learning processes including a deep neural network classifier model 260, a data segmentation model 280, a combinatorial model 284, an unsupervised classification model, etc. are used to perform operations that cannot practically be performed by a human, either mentally or with assistance, such as user-application specific segmentation. It will be appreciated that a variety of machine learning techniques can be used alone or in combination to generate any of the models disclosed herein.

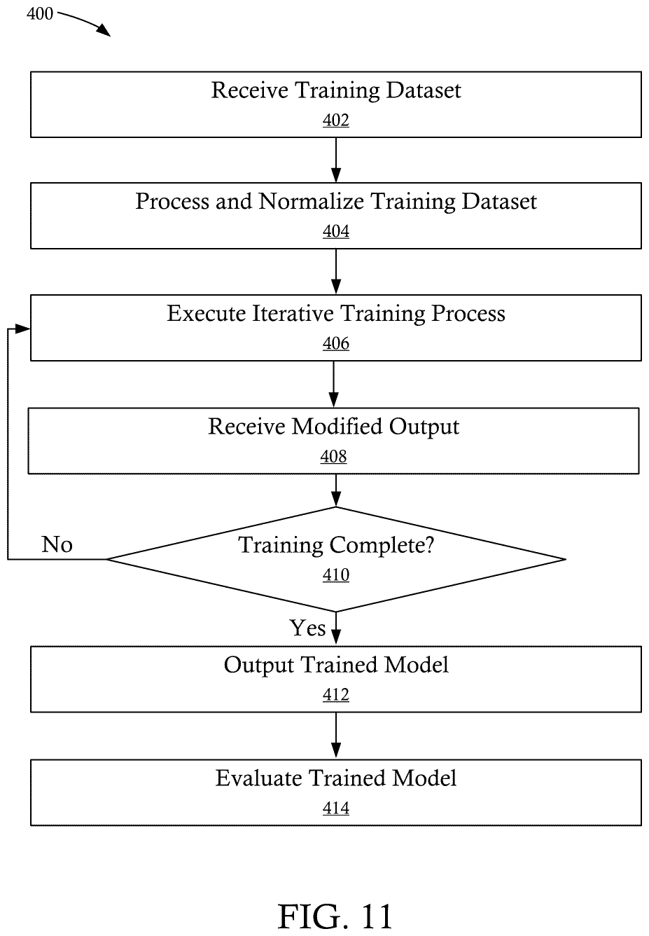

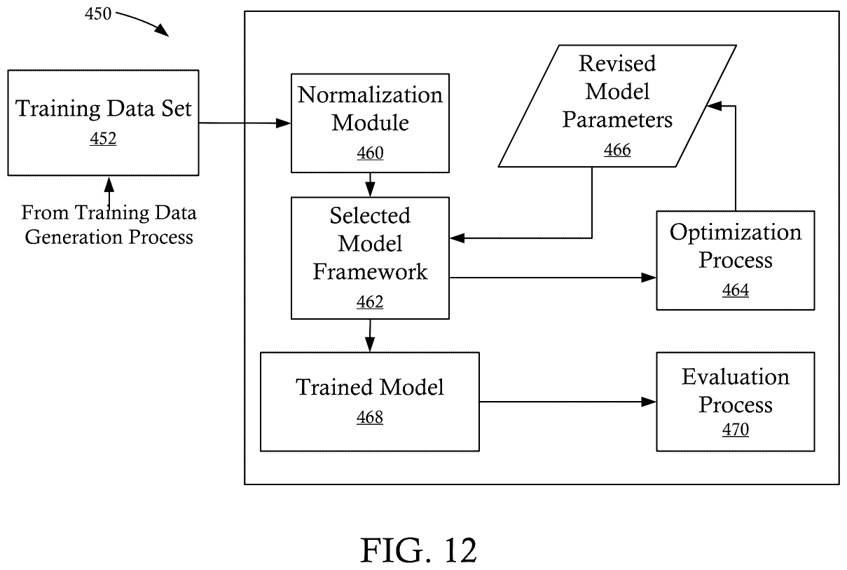

In some embodiments, a user segmentation computing device 4 can include and/or implement one or more trained models, such as a deep neural network classifier model 260, a data segmentation model 280, a combinatorial model 284, an unsupervised classification model, etc. In some embodiments, one or more trained models can be generated using an iterative training process based on a training dataset. FIG. 11 illustrates a method 400 for generating a trained model, such as a trained optimization model, in accordance with some embodiments. FIG. 12 is a process flow 450 illustrating various steps of the method 400 of generating a trained model, in accordance with some embodiments. At step 402, a training dataset 452 is received by a system, such as a processing device 10. The training dataset 452 can include labeled and/or unlabeled data. For example, in some embodiments, a training dataset can include an unlabeled dataset for training of an unsupervised classification model. As another example, in some embodiments, a training dataset can include one or more labeled datasets for training of a supervised DNN model and/or a data segmentation model.

At optional step 404, the received training dataset 452 is processed and/or normalized by a normalization module 460. For example, in some embodiments, the training dataset 452 can be augmented by imputing or estimating missing values of one or more features associated with training of an associated model. In some embodiments, processing of the received training dataset 452 includes outlier detection configured to remove data likely to skew training of a the associated model type. In some embodiments, processing of the received training dataset 452 includes removing features that have limited value with respect to training of a model.

At step 406, an iterative training process is executed to train a selected model framework 462. The selected model framework 462 can include an untrained (e.g., base) machine learning model, such as unsupervised clustering models, supervised clustering models, deep neural net frameworks, etc., and/or a partially or previously trained model (e.g., a prior version of a trained model). The training process is configured to iteratively adjust parameters (e.g., hyperparameters) of the selected model framework 462 to minimize a cost value (e.g., an output of a cost function) for the selected model framework 462.

The training process is an iterative process that generates set of revised model parameters 466 during each iteration. The set of revised model parameters 466 can be generated by applying an optimization process 464 to the cost function of the selected model framework 462. The optimization process 464 can be configured to reduce the cost value (e.g., reduce the output of the cost function) at each step by adjusting one or more parameters during each iteration of the training process.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model framework 462 has reached a minimum, such as a local minimum and/or a global minimum.

At step 410, a trained model 468, such as a trained deep neural network classifier model 260, a data segmentation model 280, a combinatorial model 284, an unsupervised classification model, etc., is output and provided for use in a data segmentation, such as the data segmentation and interface generation method 200 discussed above with respect to FIGS. 3-7. At optional step 412, a trained model 468 can be evaluated by an evaluation process 470. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
non-transitory memory storing instructions that, when executed, cause the processor to:
obtain a user data structure comprising at least one data element representative of a set of user features;
generate a segment probability for each of a plurality of segments for the user data structure, wherein the segment probability for each of a plurality of segments is generated by a deep neural net classifier model that receives a first subset of the set of user features;
generate a classification probability of the user data structure for each of the plurality of segments by a data segmentation model that receives the segment probability for each of the plurality of segments from the deep neural net classifier model and a second subset of the set of user features;
generate a user-application-segment score based on a weighted combination of the segment probability for at least one of the plurality of segments and the classification probability for the at least one of the plurality of segments, wherein the weighted combination is applied by a combinatorial model; and
modify the user data structure to include an application-specific label based on the user-application-segment score.

2. The system of claim 1, wherein the plurality of segments are determined based on an application context.

3. The system of claim 1, wherein the instructions cause the processor to verify the user-application-segment score based on an output of the deep neural net classifier model, the data segmentation model, and one or more aggregated features of a corresponding user segment.

4. The system of claim 1, wherein the deep neural net classifier model is generated by a supervised learning process using a training dataset comprising ideal candidates for each of the plurality of segments.

5. The system of claim 4, wherein the ideal candidates are identified by an unsupervised clustering model.

6. The system of claim 1, wherein the instructions cause the processor to generate an interface including at least a first customized interface element selected based, at least in part, on the user-application-segment score.

7. The system of claim 6, wherein the instructions cause the processor to:
receive feedback data including user interactions with the interface including at least the first customized interface element; and
modify at least one of the deep neural net classifier model, the data segmentation model, or the combinatorial model, at least in part, on the feedback data.

8. The system of claim 1, wherein the deep neural net classifier model generates a categorical encoding.

9. A computer-implemented method, comprising:
receiving a user data structure comprising at least one data element representative of a set of user features;
generating a segment probability for each of a plurality of segments for the user data structure, wherein the segment probability for each of a plurality of segments is generated by a deep neural net classifier model that receives a first subset of the one or more user features;
generating a classification probability of the user data structure for each of the plurality of segments by a data segmentation model that receives the segment probability for each of the plurality of segments from the deep neural net classifier model and a second subset of the one or more user features;
generating a user-application-segment score based on a weighted combination of the segment probability for at least one of the plurality of segments and the classification probability for the at least one of the plurality of segments, wherein the weighted combination is applied by a combinatorial model; and
modifying the user data structure to include an application-specific label based on the user-application-segment score.

10. The computer-implemented method of claim 9, wherein the plurality of segments are determined based on an application context.

11. The computer-implemented method of claim 9, comprising verifying the user-application-segment score based on an output of the deep neural net classifier model, the data segmentation model, and one or more aggregated features of a corresponding user segment.

12. The computer-implemented method of claim 9, wherein the deep neural net classifier model is generated by a supervised learning process using a training dataset comprising ideal candidates for each of the plurality of segments.

13. The computer-implemented method of claim 12, wherein the ideal candidates are identified by a clustering model.

14. The computer-implemented method of claim 9, comprising generating an interface including at least a first customized interface element selected based, at least in part, on the user-application-segment score.

15. The computer-implemented method of claim 14, comprising
receiving feedback data including user interactions with the interface including at least the first customized interface element; and
modifying at least one of the deep neural net classifier model, the data segmentation model, or the combinatorial model based, at least in part, on the feedback data.

16. The computer-implemented method of claim 9, wherein the deep neural net classifier model is configured to generate a categorical encoding.

17. A non-transitory computer readable medium having instructions stored thereon, wherein the instructions, when executed by at least one processor, cause at least one device to perform operations comprising:
receiving a user data structure comprising at least one data element representative of a set of user features;
generating a segment probability for each of a plurality of segments for the user data structure, wherein the segment probability for each of a plurality of segments is generated by a deep neural net classifier model that receives a first subset of the one or more user features;
generating a classification probability of the user data structure for each of the plurality of segments by a data segmentation model that receives the segment probability for each of the plurality of segments from the deep neural net classifier model and a second subset of the one or more user features;
generating a user-application-segment score based on a weighted combination of the segment probability for at least one of the plurality of segments and the classification probability for the at least one of the plurality of segments, wherein the weighted combination is applied by a combinatorial model; and
modifying the user data structure to include an application-specific label based on the user-application-segment score.

18. The non-transitory computer readable medium of claim 17, wherein the instructions cause the at least one device to perform operations comprising verifying the user-application-segment score based on an output of the deep neural net classifier model, the data segmentation model, and one or more aggregated features of a corresponding user segment.

19. The non-transitory computer readable medium of claim 17, wherein the deep neural net classifier model is generated by a supervised learning process using a training dataset comprising ideal candidates for each of the plurality of segments, and wherein the ideal candidates are identified by a clustering model.

20. The non-transitory computer readable medium of claim 17, wherein the instructions cause the at least one device to perform operations comprising:
generating an interface including at least a first customized interface element selected based, at least in part, on the user-application-segment score;
receiving feedback data including user interactions with the interface including at least the first customized interface element; and
modifying at least one of the deep neural net classifier model, data segmentation model, or combinatorial model based, at least in part, on the feedback data.
